(19) United States
(12) Patent Application Publication
(10) Pub. No.: US 2008/0086265 A1
(43) Pub. Date: Apr. 10, 2008

(54) NAVIGATIONAL SYSTEM, AS WELL AS METHOD FOR ILLUSTRATING A ROAD MAP WITH ISOLINES

(75) Inventor: Michael Heuser, Wurzburg (DE)

Correspondence Address: BLAKELY SOKOLOFF TAYLOR & ZAFMAN, 1279 OAKMEAD PARKWAY, SUNNYVALE, CA, 94085-4040, US

(73) Assignee: Navigon AG, Hamburg (DE)

(21) Appl. No.: 11/860,709

(22) Filed: Sep. 25, 2007

(30) Foreign Application Priority Data
Oct. 10, 2006 (DE) 10 2006 048 182.8

(51) Int. Cl. G01C 21/30

(52) U.S. Cl. 701/211

(57) ABSTRACT

The invention pertains to a navigation system, for example, for a motor vehicle, as well as to a method for simultaneously displaying isolines and a road map. The navigation system comprises a processor as well as a display device for displaying a road map. The invention is characterized in that the processor is designed for selecting isoline data and for displaying isolines (1, 2, 3, 4 . . . ) on the display device, wherein the illustrated road map and the isolines that correspond to the illustrated road map can be superimposed on the display device. The invention allows a much better and intuitive orientation for the user with the aid of the expanded illustration on the monitor of the navigation system. The method and navigation system ensure a technically robust combination of existing road maps and separate isoline data, namely of any arbitrary origin, which can be realized in a cost-efficient fashion.

### CROSS-REFERENCE TO RELATED APPLICATIONS

The present patent application claims priority from German Patent Application No. 10 2006 048 182.8, filed on Oct. 10, 2006.

### BACKGROUND OF THE INVENTION

The invention pertains to a navigation system, particularly for a motor vehicle, according to the preamble of claim 1, as well as to a method for simultaneously displaying isolines on a road map according to claim 11.

Navigation systems for determining the instantaneous position, for example, of persons or motor vehicles, or for determining and displaying driving routes are known. Navigation systems of this type generally comprise a display device or a monitor, on which a section of a road map can be illustrated. The monitor usually shows, in essence, the course of roads and paths within the displayed map section, as well as at least a few characteristics of the surroundings such as, for example, the contours of buildings, city areas or tree-covered regions.

Navigation systems of the generic type are usually able to display the corresponding road maps on different scales. In this case, a map section is displayed on a certain scale, for example, due to a corresponding command that is input by the user, or a certain map scale is automatically selected—particularly in dependence on the current position and/or the current driving speed—such that a very fast and intuitive orientation is possible at all times based on the displayed map section.

However, when larger map scales are selected by the navigation system while driving at higher speeds or on interurban routes, in particular, it may occur that only relatively little information is displayed on the monitor of the navigation system. For example, only the most important connecting roads, larger built-up areas or large forested areas are displayed on large map scales. This can result in only a few, if any, orientation elements being displayed on the respective monitor image in addition to the main roads while driving—particularly in sparsely populated areas.

This naturally results in the disorientation of the user because the image illustrated on the monitor practically does not provide any clues that would enable the user to check the concurrence between the map image illustrated on the navigation system and the actual surroundings or landscape in such instances. This inherent limitation of the state of the art in the illustration of maps on navigation systems can affect the driver's orientation, particularly in unfamiliar areas, or even lead to possibly hazardous uncertainty of the driver of the motor vehicle.

### SUMMARY OF THE INVENTION

Based on these circumstances, the present invention aims to develop a navigation system and a method for illustrating a road map which make it possible to overcome the inherent disadvantages of the state of the art. The invention should make it possible, in particular, to achieve a significantly improved and intuitive orientation based on the image displayed on the monitor of the navigation system; it should furthermore be possible to utilize the device and the method very easily and simultaneously with great flexibility, wherein the product should also allow a cost-efficient illustration of images.

This objective is attained with a navigation system according to claim 1 and a method with the characteristics of claim 11.

Preferred embodiments form the objects of the dependent claims.

The navigation system according to the invention is intended, in particular, but by no means exclusively, for position finding and navigation while driving a motor vehicle. For this purpose, the navigation system itself conventionally comprises a processor as well as a display device for displaying a road map.

The inventive navigation system, however, is characterized in that the processor is designed for selecting isoline data and for displaying isolines contained therein on the display device. In this case, the road map illustrated on the display device and the corresponding isolines of the illustrated road map can be superimposed on the display device.

Consequently, the information content of the illustrated road map can be significantly broadened due to the additional incorporation of isolines. This applies, in particular, to large map scales, on which pure road maps possibly show only a few details for the orientation of the user in the actual surroundings, as has been explained above.

In the context of the invention, it is not important which particular geographic characteristics are specifically represented by the isolines as long as these particularly graphic characteristics can be used for increasing the information content of the illustrated road map. According to one especially preferred embodiment of the invention, however, the isoline data comprises elevation data in the form of contour lines of identical elevation.

Such elevation data which is present in the form of isolines that represent closed contour lines, wherein each contour line represents a line of identical elevation in the terrain, makes it possible to substantially improve the readability of the map and therefore the intuitive orientation thereon. Even in instances in which no other orientation characteristics at all are displayed on the map, the contour lines of identical height illustrated on the monitor of the navigation system enable the user to get an impression of the shape of the terrain in the immediate surroundings. This allows a simple and intuitive comparison between the image illustrated on the monitor and the actual surroundings at all times such that the orientation can be significantly improved, particularly in unfamiliar areas.

According to another particularly preferred embodiment of the invention, the areas bordered by an isoline are shaded or filled with a certain color value or with a certain gray-scale value in accordance with their numerical value. This makes it possible to achieve an even better perception and distinction of the isolines. In addition, an apparently plastic map illustration can be realized—due to the different color shades of the individual contour lines—such that the fast and intuitive perception of the situation illustrated on the road map is significantly improved, wherein this aspect is particularly decisive while driving. However, not only conventional 2-D or bird's-eye view map illustrations benefit from this embodiment of the invention. The overview, in particular, of perspective map illustrations such as 2½-D or Quasi-3-D can also be significantly improved in this fashion because apparently three-dimensional contours or elevations and depressions of the landscape become visible due to the isolines such that a fast orientation can be achieved based on an intuitive comparison with the actual contour of the respective terrain.

The invention can be realized regardless of the form in which the isolines are made available and processed by the processor as long as this data can be combined with the data on which the road map is based.

According to one particularly preferred embodiment of the invention, the isoline data is stored in at least one separate isoline data file that is independent of the road map. In other words, the data that forms the basis of the road map is not dependent on the data, on which the isolines are based.

This is particularly advantageous because the isolines can be thusly illustrated on the display device completely independent of the data structure that forms the basis of the respective road map. This also makes it possible, in particular, to easily superimpose isolines on road maps that do not feature isoline information (such as, for example, elevation data). In addition, the coordinate transformation for illustrating a road map including isolines in the form of different views, particularly in 2½-D or Quasi-3-D, can also be realized in a particularly simple and reliable fashion because the isoline data is made available separately.

This embodiment of the invention furthermore makes it possible to either alter the data of the road map independently of the isoline data or, vice versa, the isoline data independently of the road map or to exchange the corresponding database with an update or another database, namely without affecting the other database in any way. For example, it is possible to utilize road maps or isoline data of different suppliers without impairing the joint illustration of the road map and the isolines on the display device of the navigation system.

According to another particularly preferred embodiment of the invention, an isoline data file is assigned to a certain limited geographic area on the road map only. In other words, this means that the isoline data of the illustrated geographic region is contained in a multitude of isoline data files, wherein each isoline data file only contains the isolines for a certain section of the road map or for a certain partial geographic area of the geographic region.

This makes it possible to achieve a superior structuring of the database and to reduce the storage capacity or the data transmission required for illustrating the isolines, wherein only the respective isoline data files are required or accessed which are assigned to a certain limited partial area of the geographic region illustrated on the road map.

According to another particularly preferred embodiment of the invention, an isoline data file comprises a multitude of data file segments, wherein each data file segment contains the isoline data of a certain geographic area tile of the geographic area corresponding to the isoline data file. This makes it possible to realize very simple and fast access, particularly sequential access, to the isoline data for an instantaneously illustrated section of the road map. This requires only a minimum of data file and computing operations because only the area tiles contacted by the instantaneously illustrated section need to be taken into account and therefore only the corresponding data file segments of the respective isoline data file need to be read out.

According to another embodiment of the invention, the isoline data is contained in the isoline data file in the form of closed polygons. This results in a particularly low storage requirement and reduces the number of computing operations required for the coordinate transformation and for displaying the isolines because the corner points of a polygon can be very easily recalculated into the respective map projection used, namely also with very little computing capacity.

According to another particularly preferred embodiment of the invention, the polygons are sequentially arranged in the data file segments of the isoline data file in the drawing sequence. This embodiment provides the advantage that the respective isoline data file or the corresponding data file segment of an isoline data file which corresponds to the instantaneously illustrated section of the road map can be processed within the data file in a purely sequential fashion without jumps. In this context, it is particularly preferred—in the sense of reducing unnecessary computing operations—to also arrange the point coordinates of a polygon or of an isoline sequentially in the isoline data file, namely in the sequence in which the points of the polygon are illustrated on the monitor of the navigation system.

In other words, this means that the isolines corresponding to an instantaneously illustrated section of the road map can be generated by sequentially reading the corresponding data of the data file segment of an isoline data file and forwarding this data to the graphics unit, wherein only a minimal number of data file offset lookups is required during the readout of the isoline data in order to read out all isoline data required for the instantaneous illustration on the monitor. This embodiment of the invention consequently makes it possible to also realize a smooth illustration of the road map including the superimposed isolines on the monitor of navigation systems that only have relatively little computing capacity.

According to another preferred embodiment of the invention, several isoline data files or several sets of isoline data files exist for one and the same geographic area. In this case, the several isoline data files or the several sets of isoline data files are respectively assigned to different image scales. This makes it possible to utilize isoline data with respectively matching, optimized detail accuracy for different image scales of the road map—for example, when illustrating large map scales—without having to process unnecessarily accurate and therefore dispensable data by means of the processor of the navigation system.

The invention furthermore pertains to a method for simultaneously displaying isolines and a roadmap on the display device of a navigation system. In this case, the inventive method comprises the steps described below.

In a first step, the geographic position of the navigation system is initially determined or an already determined geographic position is initially acquired. Subsequently, the section of a road map corresponding to the determined geographic position is displayed on the display device or the illustration of the corresponding section of the road map on the display device is prepared by the processor of the navigation system in another step.

The processor then selects an isoline data file that matches the determined geographic position of the navigation system and the instantaneous scale of the road map. Subsequently, the isolines enclosed or contacted by the current map section are read out of the selected isoline data file. The isolines are finally illustrated on the display device in another step by means of corresponding drawing routines. The isolines and the map are illustrated in a superimposed fashion in this case.

According to one particularly preferred embodiment of the inventive method, the isoline data is formed of elevation data in the form of contour lines of identical elevation. Due to the utilization of contour lines of identical elevation, the readability and the intuitive orientation of the user on the map are improved because the shape of the surrounding terrain with depressions and elevations can be recognized due to the additional and simultaneous illustration of the contour lines on the road map.

According to other particularly preferred embodiments of the inventive method, the isoline data is stored in at least one separate isoline data file that is independent of the road map or an isoline data file is assigned to a certain limited area on the road map. In this case, an isoline data file preferably comprises a multitude of data file segments, wherein each data file segment of the isoline data file contains the isoline data of a certain geographic area tile. This results in very simple and fast access, particularly sequential access, to the isoline data that is assigned to an instantaneously illustrated section of the road map or a section of the road maps to be illustrated. This is achieved with a minimum of data access and computing operations because only the area tiles or data file segments contacted by the instantaneously illustrated map section or the map section to be illustrated need to be taken into account and read out.

According to other preferred embodiments of the inventive method, the isoline data is contained in the isoline data file in the form of closed polygons, wherein the polygons or isolines are sequentially arranged within the isoline data file in the sequence in which they are generated on the monitor or display device of the navigation system. In this case, it is particularly preferred—in the sense of reducing unnecessary computing operations—to also arrange the point coordinates of a polygon or an isoline sequentially in the isoline data file in the sequence in which the points of the polygon are illustrated on the monitor of the navigation system.

According to other embodiments of the inventive method, areas bordered by an isoline or by a polygon are shaded with a certain color value or a certain gray-scale value in accordance with their numerical value when they are displayed on the monitor of the navigation system or the isolines are drawn successively in the sequence of their numerical value, for example, in accordance with their increasing elevation above mean sea level. An even better perception of the map image and an apparently plastic map illustration can thus be realized due to the different color shades of the areas bordered by an isoline. Since the isolines are generated in accordance with the sequence of their numerical value, such a relief can be generated on the monitor in a particularly simple fashion and with particularly little computing capacity, namely because the complete isolines or polygons are drawn in a successive fashion and can respectively be completely filled out with the corresponding color value without having to computationally subtract the areas of subpolygons when the respective superpolygon is filled out.

According to another preferred embodiment of the inventive method, a multitude of isoline data files or several sets of isoline data files exist for one and the same geographic region. The multitude of isoline data files or the several sets of isoline data files are respectively assigned to different image scales and contain the isolines in correspondingly different resolutions. This makes it possible to utilize isoline data files with respectively matching, optimized detail accuracy for different image scales of the road map. It is simultaneously prevented—for example, when illustrating large map scales—that unnecessarily accurate and therefore unnecessarily extensive data needs to be handled by the processor of the navigation system.

### BRIEF DESCRIPTION OF THE DRAWINGS

The invention is described in greater detail below with reference to the Figs. that show merely exemplary embodiments.

The Figs. show:

FIG. 1, a schematic representation of a geographic region, within which a navigation system is situated;

FIG. 2, a representation according to FIG. 1 of the geographic region shown in FIG. 1, namely with superimposed tiling;

FIG. 3, a representation according to FIGS. 1 and 2 of the geographic region shown in FIG. 2, namely once again with superimposed tile structure;

FIG. 4, an enlarged representation according to FIGS. 1 to 3 of a section of an image illustrated on the monitor of a navigation system, as well as the data file structure of the corresponding isoline data file;

FIG. 5, a schematic representation of the data file structure of an isoline data file according to FIG. 4;

FIG. 6, a section of an image illustrated on the monitor of a navigation system in the form of a 2-D view;

FIG. 7, a representation according to FIG. 6 of a section of an image illustrated on the monitor in the form of a 2½-D or Quasi-3-D view; and

FIG. 8, a representation according to FIG. 6 of the image illustrated on the monitor in FIG. 6 without isolines.

### DETAILED DESCRIPTION OF THE INVENTION

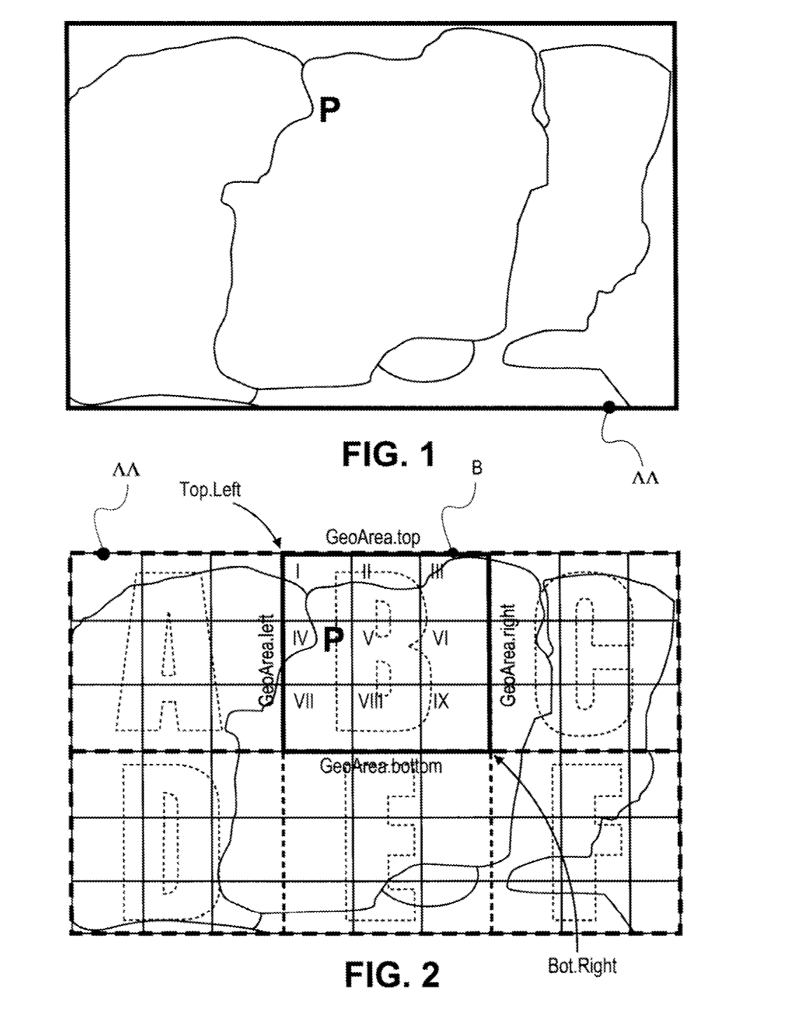

FIG. 1 shows a schematic representation of a geographic region or a map M, within the map region of which the navigation system such as, for example, a navigation system of a motor vehicle, is currently situated. One can distinguish a few schematically illustrated area boundaries, as well as the instantaneous geographic position P of the motor vehicle and of the navigation system which is determined by the navigation system and marked with “P,”

FIG. 2 shows the same map region M as FIG. 1, wherein a grid is superimposed on the map region M in FIG. 2. In this case, the grid corresponds to a logical division of the map region M into tiles. The division of the map region M into tiles serves for storing the isoline data assigned to the map region M—for example, the data of isohypses or contour lines—in corresponding isoline data files in a precisely structured fashion.

The square B bordered by a bold line in FIG. 2 symbolizes the extent of the geographic area B or the extent of one of the six isoline data files A, B, C, D, E, F assigned to the map region M. In this case, the coordinates of the corner points [Top.Left] and [Bot.Right] of the square B are defined as follows based on the given boundaries of the geographic area B [GeoArea.left], [GeoArea.right], [GeoArea.top], [GeoArea.bottom]:

Top.Left={GeoArea.left, GeoArea.top}

and

Bot.Right={GeoArea.right, GeoArea.bottom}.

In order to reference the section IV or the tile IV of the isoline data file “B” and to directly access the corresponding section IV within the isoline data file “B,” within which the current geographic position P of the navigation system is situated, it is necessary to deduce the corresponding section IV of the isoline data file “B” based on the current geographic position P.

This is preferably realized as described below (on the example of the geographic area B and the tile IV situated therein).
Referencing the tile-ID and the isoline data to be drawn which is contained therein based on the geographic position P (x, y) of the navigation system:
a) Determining the number of columns [Number.Columns] based on the given width of the geographic area B [GeoArea.Width} and based on the given width of the tiles [Tile size.x]:
   Number.Columns
=1+(GeoArea.Width/Tile size.x)*
b) Determining the column [Current.Column] in which the navigation system is currently situated at the position P based on the given left boundary [GeoArea.left] of the geographic area B, based on the geographic width [x] of the instantaneous position P and based on the given width of the tiles [Tile size.x]:
   Current.Column
minimum of {(x−[GeoArea.left)/Tile size.x, Number.Columns−1}*
c) Determining the number of lines [Number.Lines] based on the given height of the geographic area B [GeoArea.Height] and based on the given height of the tiles [Tile size.y]:
   Number.Lines
1+(GeoArea.Height/Tile size.y)*
d) Determining the line [Current.Line] in which the navigation system is currently situated at the position P based on the given upper boundary [GeoArea.top] of the geographic area B, based on the geographic length [y] of the instantaneous position P and based on the given height of the tiles [Tile size.y]:
   Current.Line
=minimum of {(y−GeoArea.top)/Tile size.y, Number.Lines−1}*
e) Determining the serial number [Tile.No] of the tile in which the navigation system is currently situated at the position P:
   Tile.No
=Current.Line*Number.Columns+Current.Column
*) The numeral 1 is respectively added and subtracted again in order to make it possible to carry out the calculation with integral variables in this case. Since possibly created decimal places are cut off in this case, a residual line or residual column at the edge of the geographic area may be respectively lost. For reasons of simplicity, a line and a column generally are therefore additionally stored, namely regardless of the fact whether it respectively is partially filled or empty.

In the example illustrated in FIGS. 1 and 2, this results in the value Tile.No=4 for the serial number of the tile IV containing the instantaneous position P of the navigation system. The position P of the navigation system therefore is situated in the tile IV.

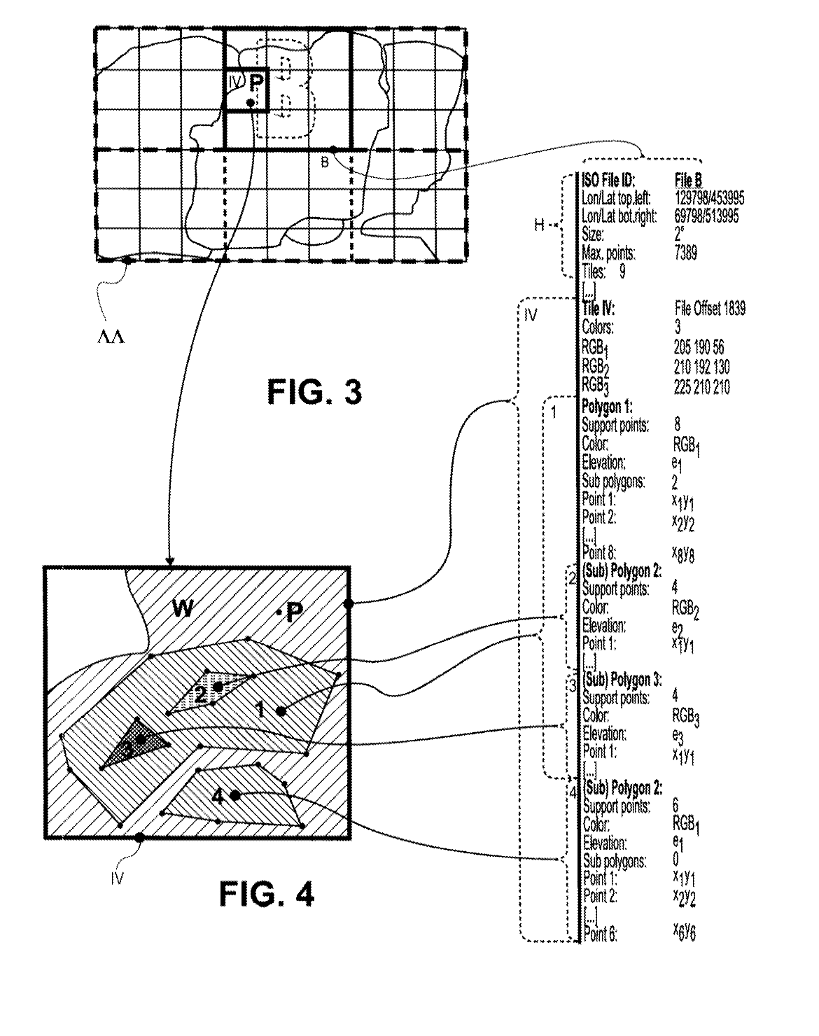

FIGS. 3 and 4 show how the corresponding isoline data is determined and illustrated on the monitor of the navigation system based on the previously determined number of the tile IV, the geographic position of which corresponds to the position P of the navigation system.

For this purpose, the navigation system merely needs to initially select the isoline data file B that belongs to the geographic area B and subsequently jump to the position 1839 that corresponds to the previously determined tile IV within the selected isoline data file B. In the present example, the isoline data belonging to the tile IV begins in the isoline data file B at the position identified by the data file offset pointer 1839.

The navigation system therefore jumps to the position in the isoline data file B which is identified by the pointer 1839 and now only needs to successively process the isolines 1, 2, 3, 4 . . . beginning at this position and successively illustrate the polygon data contained therein on the monitor.

This process is symbolically illustrated in FIG. 4, on the left side of which a monitor section of the navigation system that corresponds to the area tile IV is illustrated with an area characteristic W (for example, a forest) displayed on the monitor and with a number of already drawn polygon data or isolines 1 to 4. The corresponding data file segment of the isoline data file B which is assigned to the geographic area B in FIG. 3 is schematically illustrated on the right side of FIG. 4.

The isoline data file B comprises a data file header H that contains information for identifying the data file (in this example, “File B”), information on the size of the geographic area B covered by the isoline data file B, as well as information on the maximum number of corner points per polygon 1, 2, 3, 4 . . . The latter serves, in particular, for adjusting a corresponding data file buffer with such a size that the maximum polygon size [max.points] expected just fits into the data file buffer already before the actual drawing routine in order to save space.

After the data file header H, the isoline data file B contains the data of the nine tiles I to IX of the isoline data file B in a linearly continuous fashion, wherein the isolines 1, 2, 3, 4 . . . contained in the respective tiles I to IX or the corresponding polygon data are respectively indicated for each of the tiles I to IX. This data comprises, in particular, the number of colors used in the respective tiles I to IX and the corresponding color values of the polygons 1, 2, 3, 4 . . . , as well as the numerical values linked with the polygons or isolines 1, 2, 3, 4 . . . (in the case of isohypses, in particular, the elevation above mean sea level) and the actual coordinates of the corner points of the polygon data or isolines l, 2, 3, 4 . . . . In this case, the data of the individual isolines or polygons 1, 2, 3, 4 . . . , as well as the data of the corner points of each polygon, are contained in the isoline data file B in the form of a strictly successive linear arrangement.

This specific arrangement of the data contained in the isoline data file B provides the decisive advantage that the corresponding drawing routines of the navigation system can process the data of the isoline data, file B beginning with the corresponding data file offset (in the discussed example, the tile IV with the data file offset 1839) without any data file jumps. Consequently, the data contained in the isoline data file B can be cycled in a purely successive fashion and with a minimum of computing operations such that the polygons or isolines 1, 2, 3, 4 . . . can be illustrated on the monitor of the navigation system in the correct sequence—with the lowest computing expenditure possible and with the highest drawing speed possible.

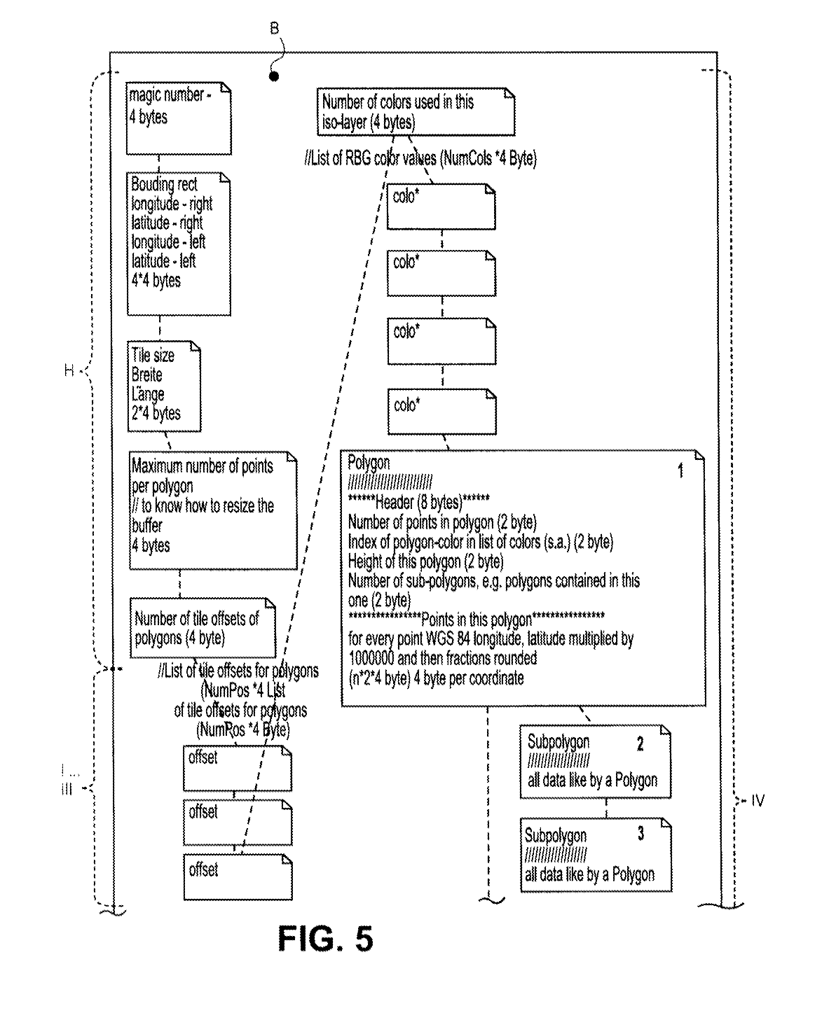

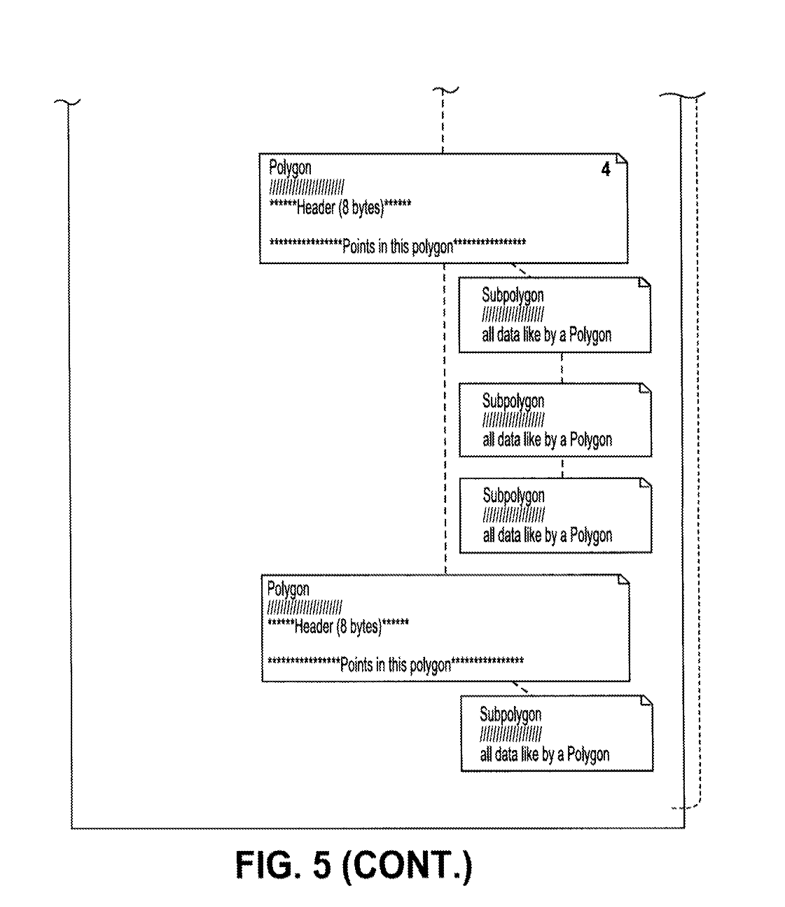

FIG. 5 once again shows in more detailed and graphical form the data file structure of one exemplary embodiment of an isoline data file B. One can distinguish, in particular, the data file header H with the comprehensive tile information on the geographic area B covered by the isoline data file “File B,” as well as the data file segments 1, II, III, IV . . . serving as placeholders and containing the information on the individual tiles I to III and, with respect to the tile IV, the contents and information on the individual isolines or polygons and subpolygons 1, 2, 3, 4 . . . contained in the tile IV.

This figure also makes it clear that the special, strictly linear data file structure of the illustrated isoline data file B makes it possible to achieve a particularly simple and fast calculation and illustration of the isolines 1, 2, 3, 4 . . . on the monitor of the navigation system. In addition, such an isoline data file can—as already described in detail above—be combined with the data of any road map, wherein the road map and the isoline data can always be simultaneously made available, handled and, if applicable, exchanged or updated completely separate of one another.

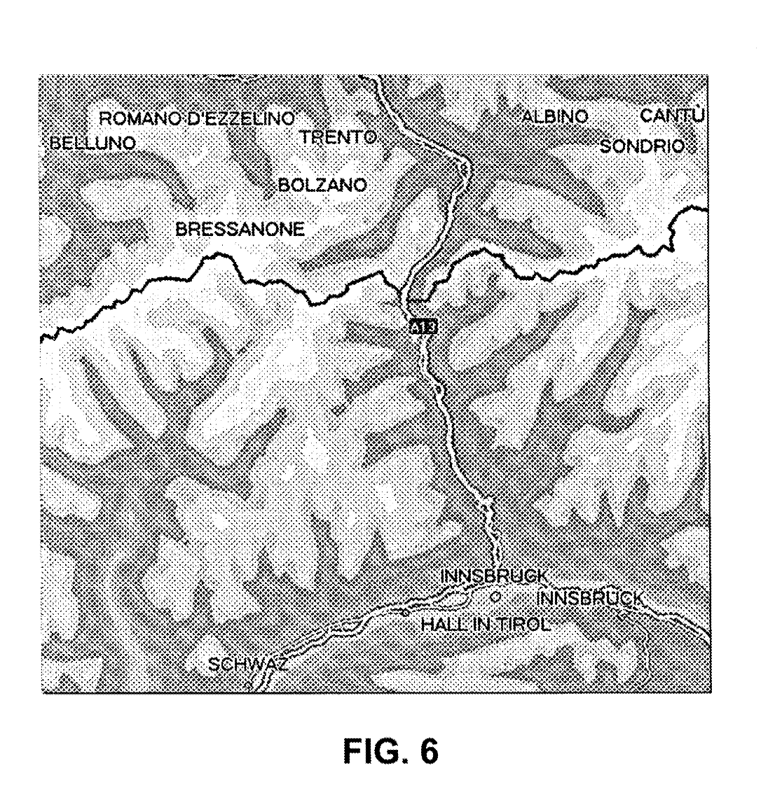

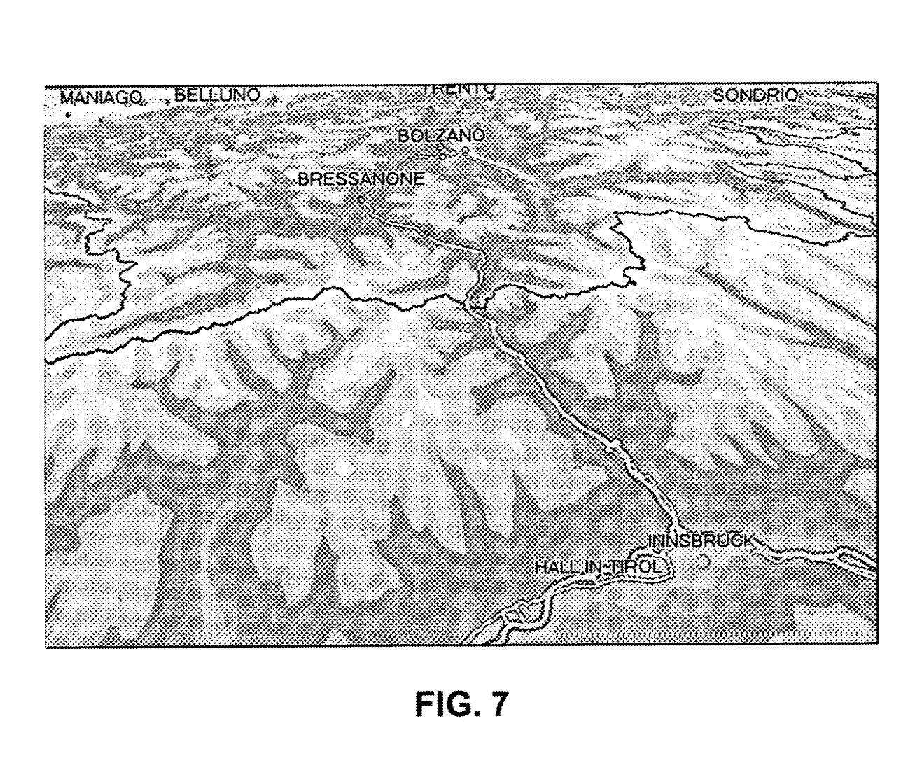

In FIGS. 6 and 7, it is once again graphically symbolized which decisive improvements can be achieved in the illustration and intuitive perception of a road map if the road map is illustrated with additional isohypses or contour line data. Although neither FIG. 6 nor FIG. 7 by no means shows a true three-dimensional illustration, the perspectively tilted 2½-D or Quasi-3-D illustration shown in FIG. 7 and the 2-D illustration shown in FIG. 6 that corresponds to a bird's-eye view impart a downright plastic image of the landscape relief due to the isolines that are shaded differently in dependence on the elevation above mean sea level.

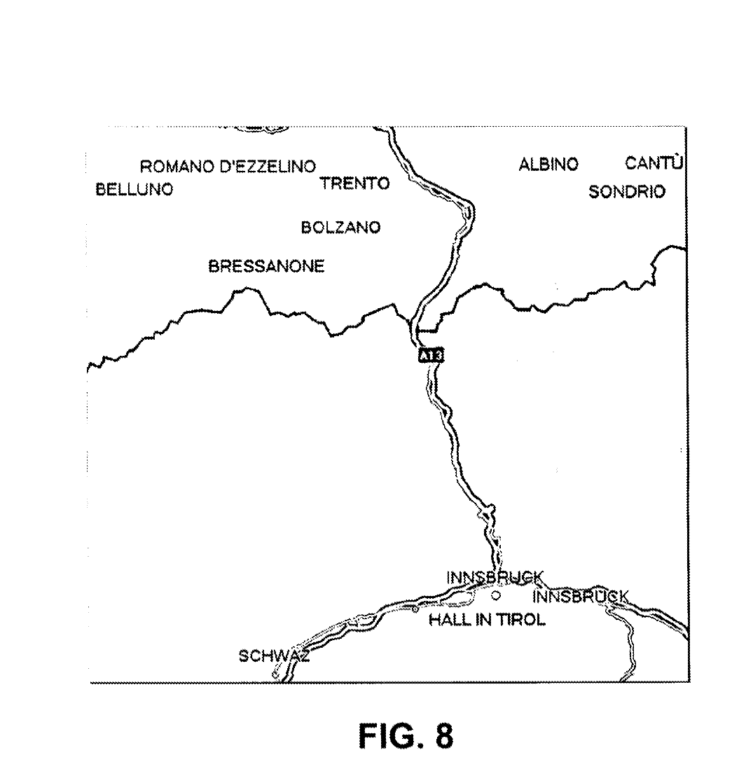

FIG. 8 shows the road map illustrating exactly the same map section as FIGS. 6 and 7, however, without isolines and without corresponding shades of gray. In comparison with the map illustrations according to FIGS. 6 and 7, one can immediately recognize the minimal information content—for example, for the driver of a motor vehicle—and the thusly very limited orientation options of the road map according to FIG. 8.

This clearly demonstrates that the invention makes it possible to decisively improve the quality of the illustration of road maps on monitors of navigation systems, as well as the associated intuitive orientation of the user in the surroundings.

The invention makes it possible, in particular, to combine existing road maps with separate isoline data, namely of any arbitrary origin, in a constructively and technically simple and therefore cost-efficient fashion.

The invention consequently provides a decisive contribution to improving the illustration of road maps on navigation systems, as well as to improving the orientation and safety of the user during the utilization of navigation systems, particularly in motor vehicles.

### LIST OF REFERENCE SYMBOLS

M Geographic region, map
P (x, y) Current geographic position
A, B, C, D . . . Partial geographic area, isoline data file
I, II, III, IV . . . Area tile, data file segment
1, 2, 3, 4 . . . Isoline, isohypse, polygon
H Data file header
W Area characteristic
[Number.Columns] Number of columns of the geographic area
[Number.Lines} Number of lines of the geographic area
[Current.Column] Column of the geographic area that contains P
[Current.Line] Line of the geographic area that contains P
[GeoArea.Width] Width of the geographic area
[GeoArea.Height] Height of the geographic area
[GeoArea.left] Left/western boundary of the geographic area
[GeoArea.right] Right/eastern boundary of the geographic area
[GeoArea.top] Upper/northern boundary of the geographic area
[GeoArea.bottom] Lower/southern boundary of the geographic area
[Top.Left] North-eastern corner coordinate of the geographic area
[Bot.Left] South-western corner coordinate of the geographic area
[Tile size.x] Width of the tile
[Tile size.y] Height of the tile
[Tile.No] Serial number of the tile that contains P
[max.points] Maximum polygon size of the isoline data file

What is claimed:

1. A navigation system, particularly for a motor vehicle, wherein said navigation system comprises a processor as well as a display device for displaying a road map,
characterized in that
the processor is designed for selecting isoline data and for displaying isolines (1, 2, 3, 4 . . . ) on the display device, wherein the illustrated road map and the isolines (1, 2, 3, 4 . . . ) that correspond to the illustrated road map can be superimposed on the display device.

2. The navigation system according to claim 1,
characterized in that
the isoline data comprises elevation data in the form of contour lines of identical elevation (1, 2, 3, 4 . . . ).

3. The navigation system according to claim 1,
characterized in that
areas bordered by an isoline (1, 2, 3, 4 . . . ) are shaded with a different color value or a different gray-scale value in accordance with their numerical value.

4. The navigation system according to claim 1,
characterized in that
the isoline data is stored in at least one separate isoline data file (File A, B, C, D . . . ) that is independent of the road map.

5. The navigation system according to claim 4,
characterized in that
the at least one isoline data file (File A, B, C, D . . . ) is assigned to a certain limited area (A, B, C, D . . . ) on the road map.

6. The navigation system according to claim 4,
characterized in that
the isoline data file (File A, B, C, D . . . ) comprises a multitude of data file segments (I, II, III, IV . . . ), wherein each data file segment contains the isoline data of a certain geographic area tile (I, II, III, IV . . . ).

7. The navigation system according to claim 4,
characterized in that
the isoline data is contained in the isoline data file (File A, B, C, D . . . ) in the form of closed polygons (1, 2, 3, 4 . . . ).

8. The navigation system according to claim 7,
characterized in that
the polygons (1, 2, 3, 4 . . . ) are sequentially arranged in the data file segments (I, II, III, IV . . . ) of the isoline data file (File A, B, C, D . . . ) in the drawing sequence.

9. The navigation system according to claim 7,
characterized in that
the point coordinates of a polygon (1, 2, 3, 4 . . . ) are sequentially arranged in the isoline data file in the drawing direction of the polygon (1, 2, 3, 4 . . . ).

10. The navigation system according to claim 4,
characterized in that
several isoline data files (File A, B, C, D . . . ) or several sets of isoline data files exist for a geographic region (M) and are respectively assigned to different image scales.

11. A method for simultaneously illustrating isolines (1, 2, 3, 4 . . . ) and a road map on the display device of a navigation system, wherein the navigation system features a processor, and wherein the method comprises:
a) determining the geographic position (P) of the navigation system;
b) displaying the section of the road map that corresponds to the geographic position (P) on the display device;
c) selecting an isoline data file (File A, B, C, D . . . ) that corresponds to the geographic position (P) and to the scale of the displayed road map by means of the processor;
d) reading out the isolines (1, 2, 3, 4 . . . ) enclosed by the illustrated map section from the isoline data file (File A, B, C, D . . . ), and
e) drawing the isolines (1, 2, 3, 4 . . . ) on the display device, wherein the isolines (1, 2, 3, 4 . . . ) and the map are illustrated in a superimposed fashion.

12. The method according to claim 11,
characterized in that
the isoline data is formed of elevation data in the form of contour lines of identical elevation (1, 2, 3, 4 . . . ).

13. The method according to claim 11,
characterized in that
the isoline data is contained in at least one separate isoline data file (File A, B, C, D . . . ) that is independent of the road map.

14. The method according to claim 13,
characterized in that
the at least one isoline data file (File A, B, C, D . . . ) is assigned to a certain limited area (A, B, C, D . . . ) on the road map.

15. The method according to claim 13,
characterized in that
an isoline data file (File A, B, C, D . . . ) comprises a multitude of data file segments (I, II, III, IV . . . ), wherein each data file segment contains the isoline data of a certain geographic area tile (I, II, III, IV . . . ).

16. The method according to claim 13,
characterized in that
the isoline data is contained in the isoline data file (File A, B, C, D . . . ) in the form of closed polygons (1, 2, 3, 4 . . . ).

17. The method according to claim 16,
characterized in that
the polygons (1, 2, 3, 4 . . . ) are sequentially arranged in the isoline data file (File A, B, C, D . . . ) in the drawing sequence.

18. The method according to claim 16,
characterized in that
the point coordinates of a polygon (1, 2, 3, 4 . . . ) are sequentially arranged in the isoline data file (File A, B, C, D . . . ) in the drawing direction of the polygon (1, 2, 3, 4 . . . ).

19. The method according to claim 11,
characterized in that
areas bordered by an isoline (1, 2, 3, 4 . . . ) are shaded with a different color value or a different gray-scale value in accordance with their numerical value.

20. The method according to claim 11,
characterized in that
the isolines (1, 2, 3, 4 . . . ) are drawn in accordance with the sequence of their numerical value.

21. The method according to claim 13,
characterized in that
a multitude of isoline data files (File A, B, C, D . . . ) or several sets of isoline data files exist for a geographic region (M) and are respectively used for generating the polygons or isolines (1, 2, 3, 4 . . . ) on the display device in dependence on the instantaneous image scale.
